(19) United States
(12) Patent Application Publication
(10) Pub. No.: US 2017/0123996 A1
(43) Pub. Date: May 4, 2017

(54) Direct Mapped Files in Virtual Address-Backed Virtual Machines

(71) Applicant: Microsoft Technology Licensing, LLC, Redmond, WA (US)

(72) Inventors: Arun U. Kishan, Kirkland, WA (US); Mehmet Iyigun, Kirkland, WA (US); Landy Wang, Honolulu, HI (US); Kevin Michael Broas, Kirkland, WA (US); Yevgeniy M. Bak, Redmond, WA (US)

(21) Appl. No.: 15/155,964

(22) Filed: May 16, 2016

Related U.S. Application Data
(60) Provisional application No. 62/249,823, filed on Nov. 2, 2015.

(51) Int. Cl. G06F 12/10; G06F 9/455; G06F 12/02

(52) U.S. Cl. CPC G06F 12/10; G06F 12/0284; G06F 9/45558; G06F 2009/45583

(57) ABSTRACT

Mapping files in host virtual address backed virtual machines. A method includes receiving a request from a guest virtual machine for a file from a host. The method further includes, at the host determining that the file can be directly mapped to a physical memory location for virtual machines requesting access to the file. The method further includes, at the host, providing guest physical memory backed by the file flapping in host virtual memory.

### CROSS-REFERENCE TO RELATED APPLICATIONS

This application claims the benefit of and priority to U.S. Provisional Patent Application Ser. No. 62/249,823 filed on Nov. 2, 2015 and entitled “Direct Mapped Files in Virtual Address-Backed Virtual Machines,” which application is expressly incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc. Modernly, computing systems may implement the concept of virtual computing. In virtual computing a host physical machine (hereinafter “host”) may host a number of guest virtual machines (hereinafter “guests” or “virtual machines”). The virtual machines share physical resources on the host. For example, the virtual machines use physical processors and physical memory at the host to implement the virtual machines.

Currently virtual machines' physical memory is backed by non-paged physical memory allocations in the host in a one to one fashion The virtualization stack that manages virtual machines allocates this type of memory from the host and the host has no control over that memory after allocation. The virtualization stack fully manages that memory after it is allocated. It chooses how to distribute the memory between virtual machines, whether to make it pageable from the nest's point of view, etc.

Increasing virtual machine density on a host has become an important part of virtualization solutions to be able to take better advantage of server hardware by packing more virtual machines (while having those virtual machines perform well enough to run their desired workloads). Currently virtual machine density is mostly limited by host memory size. Thus, for example, if a host machine has 12 GB of RAM that can be allocated to virtual machines, that host can only host a number of virtual machines where the total memory for all of the virtual machines together is 12 GB or less.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a virtual computing environment. The method includes acts for mapping files in host virtual address backed virtual machines. The method includes receiving a request from a guest virtual machine for a file from a host. The method further includes, at the host determining that the file can be directly mapped to a physical memory location for virtual machines requesting access to the file. The method further includes, at the host, providing guest physical memory backed by the file mapping in host virtual memory.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will he obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system including virtual address backed physical memory for virtual machines;

FIG. 2 illustrates an example of mapping a file from a host accessible by guest virtual machines directly into guest physical address space backed by file mapping at the host; and

FIG. 3 illustrates a method of mapping files in host virtual address backed virtual machines.

### DETAILED DESCRIPTION

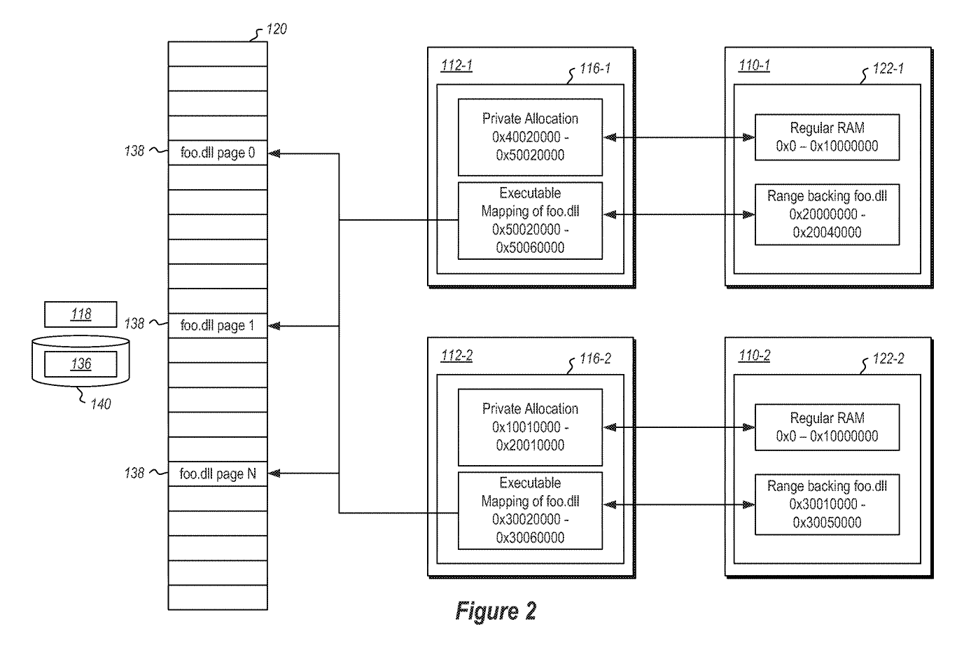

Whenever code running in a virtual address (VA)-backed virtual machine (VM), as will be illustrated in more detail below, accesses a file page from disk (see e.g., file 136 stored on disk 140 illustrated in FIG. 2), the file page's contents is transferred from the host (e.g., from a virtual hard drive (VHD), etc) into a VM's physical memory (where the VM is a guest running on a host machine), which is in-turn backed by virtual memory allocated in a host process. If there are multiple such VMs running on the host and they access the same file on the host, two different physical pages are consumed on the host to back the guest physical pages that contain the same file data. Because those host pages have identical contents, there is an opportunity to reduce memory usage. Traditionally, the way to do this is to use memory manager page combiner functionality to combine identical pages on the host but this has a cost in terms of resource consumption for creating the individual pages and then later combining the pages into a shared page. Further, this can introduce memory usage spikes that occur when creating individual pages and/or before the pages are combined. For example, consider a case where multiple identical VMs are created near simultaneously. The creation of the multiple identical VMs will result in a host physical memory usage spike at creation time for the multiple VMs, where much of the used memory has identical contents.

Embodiments may be implemented where files from the host that are accessible by the guest VM can be mapped directly into the guest physical address space and be backed by a regular file mapping on the host. Additionally or alternatively, multiple VMs can directly map the same files on the host and thus immediately share the host physical pages needed to access those files without consuming additional guest physical pages. Additionally, or alternatively, the direct mapped files can be executable files that VMs can simultaneously execute from and share the physical pages on the host.

As a foundation, the following illustrates how guest physical memory is mapped to host virtual memory. This functionality can be used to directly map files for guest virtual machines backed by host virtual addresses.

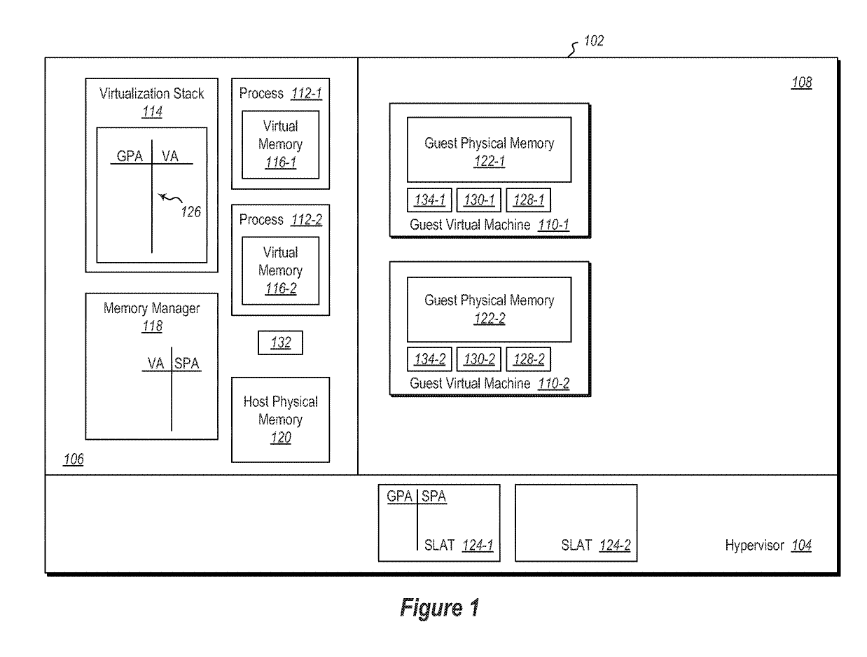

Referring now to FIG. 1, a host 102 is shown. The host 102 may be a physical host server machine capable of hosting a number of guest virtual machines. The host 102 includes a hypervisor 104. A hypervisor is a piece of computer software, firmware and/or hardware that manages virtual machines on a host.

The host 102 includes a host portion 106 and a guest portion 108. The host portion 106 hosts user-mode processes for the host 102 itself The guest portion 108 host guest virtual machines. In the example illustrated, the guest portion 108 hosts guest 110-1 and guest 110-2. While only two guest virtual machines are illustrated, it should be appreciated the host 102 is capable of hosting more virtual machines than this.

Embodiments may be implemented where a user-mode process is implemented in the host portion 106 to provide virtual memory 116 for backing guest virtual machines in the guest portion 108. In the particular example illustrated, a user-mode process is created for each guest machine. Thus, FIG. 1 illustrates user-mode processes 112-1 and 112-2 corresponding to virtual machines 110-1 and 110-2 respectively. However, it should be appreciated that a single user-mode process could be used for multiple virtual machines, or multiple processes may be used for a single virtual machine. Alternatively, virtual memory 116 could be implemented in other fashions than using a user-mode process as will be illustrated below.

The virtualization stack 114 allocates regular virtual memory (e.g., virtual memory 116-1 and 116-2 in processes 112-1 and 112-2 respectively) in the address space of a designated user-mode process that will host the virtual machine. The host memory manager 118 can treat this memory as any other virtual allocation, which means that it can be paged, the physical page backing it can be changed for the purposes of satisfying contiguous memory allocations elsewhere on the system, the physical pages can be shared with another virtual allocation in another process (which in-turn can be another virtual machine backing allocation or any other allocation on the system). At the same time, many optimizations are possible to make the host memory manager treat the virtual machine backing virtual allocations specially as necessary. Also, if the virtualization stack 114 chooses to prioritize performance over density, it can perform many operations supported by the operating system memory manager 118 such as locking the pages in memory 120 to ensure that the virtual machine will not experience paging for those portions. Similarly, large pages can be used to provide even more performance for the virtual machine as necessary.

A given virtual machine (e.g., virtual machine 110-1) can have all of its guest physical memory addresses in guest physical memory (e.g., guest physical memory 122-1) backed by virtual memory (e.g., virtual memory 116-1) or can have some of its guest physical memory addresses in guest physical memory (e.g., guest physical memory 122) backed by virtual memory (e.g., virtual memory 116) and some by legacy mechanisms such as non-paged physical memory allocations made from the host memory 120.

When a new virtual machine (e.g., virtual machine 110-1) is created, the virtualization stack 114 uses a user-mode process (e.g., user-mode process 112-1) to host the virtual memory allocation to back the physical memory (e.g., guest physical memory 122-1) of the virtual machine 110-1. This can be a newly created empty process, an existing process hosting multiple virtual machines, or a process per virtual machine that also contains other virtual machine-related virtual allocations that are not visible to the virtual machine itself (e.g., virtualization stack data structures). It's also possible to use kernel virtual address space to back the virtual machine. Once such a process is found or created, the virtualization stack 114 makes a private memory virtual allocation (or a section/file mapping) in its address space that corresponds to the amount of guest physical memory 122-1 the virtual machine 110-1 should have. Specifically, the virtual memory can be a private allocation, a file mapping, a pagefile-backed section mapping or any other type of allocation supported by the host memory manager 118. This does not have to be one contiguous allocation. It can be an arbitrary number of allocations and each allocation effectively describes a physical range of memory in the host physical memory 120 of the corresponding size in the virtual machine 110-1.

Once the virtual memory allocations have been made, they are registered with the components that will manage the physical address space of the virtual machine 110-1 and keep it in sync with the host physical memory pages that the host memory manager 118 will choose to back the virtual memory allocations. These components are the hypervisor 104 and the virtualization stack 114 that is part of the host kernel and/or a driver. The hypervisor 104 manages the guest physical memory address ranges by utilizing SLAT (Second Level Address Translation) features in the hardware. In particular, FIG. 1 illustrates a SLAT 124-1 and a SLAT 124-2 corresponding to the virtual machines 110-1 and 110-2 respectively. The virtualization stack 114 updates the SLAT 124-1 with the host physical memory pages that are backing the corresponding guest physical memory pages. The hypervisor 104 exposes the ability for the virtualization stack 114 to receive intercepts when a certain access type is performed by the guest virtual machine 110 to a given guest physical memory address 122-1. For example, the virtualization stack 114 can request to receive an intercept when a certain physical address is written by the guest virtual machine 110.

When a virtual machine 110-1 is first created, its SLAT 124-1 does not contain any valid entries because no host physical memory addresses have been allocated to back the guest physical memory addresses (although as illustrated below, in some embodiments, the SLAT 124-1 can be prepopulated for some guest physical memory addresses at or around the same time as the creation of the virtual machine 110-1). The hypervisor 104 is aware of the guest physical memory address ranges the virtual machine 110-1 is composed of, although none of them are backed by any host physical memory at this point. When the guest virtual machine 110-1 begins execution, it will begin to access its (guest) physical memory pages. As each new physical memory address is accessed, it will generate an intercept of the appropriate type (read/write/execute) since the corresponding SLAT entry is not populated with host physical memory addresses (represented as SPAs) yet. The hypervisor 104 receives the guest access intercept and forwards it to the virtualization stack 114 running in the host. The virtualization stack 114 refers to its data structure 126 indexed by guest physical memory address range to find the virtual address range that is backing it (and the host process 112-1 whose virtual address space the backing was allocated from). At that point, the virtualization stack 114 knows the specific host virtual memory address that corresponds to the guest physical memory address that generated the intercept.

The virtualization stack 114 then issues a virtual fault to the host memory manager 118 in the context of the host process 112-1 hosting the virtual address range. It does this by attaching to the process address space if necessary. The virtual fault is issued with the corresponding access type (read/write/execute) of the original intercept that occurred when the guest virtual machine 110-1 accessed its physical address in guest physical memory 122-1. A virtual fault executes basically the same code path as a regular page fault would take to make the specified virtual address valid and accessible by the host CPU. The one difference is that this code path returns the physical page number that the memory manager 118 used to make the virtual address valid. This physical page number is the host physical memory address (SPA) that is backing the virtual address and is in-turn backing the guest physical memory address that originally generated the access intercept in the hypervisor 104. At this point, the virtualization stack 114 updates the SLAT entry in the SLAT 124-1 corresponding to the original guest physical memory address that generated the intercept with the host physical memory address and the access type (read/write/execute) that was used to make the virtual address valid in the host. Once this is done, the guest physical memory address is immediately accessible with that access type to the guest virtual machine 110-1 (e.g., a parallel virtual processor in the guest virtual machine 110-1 can immediately access it without hitting an intercept). The original intercept handling is complete and the original virtual processor that generated the intercept can retry its instruction and proceed to access the memory now that the SLAT entry has been filled.

If and/or when the host memory manager 118 decides to perform any action that could or would change the physical address backing of the virtual address that was made valid via a virtual fault, it will perform a translation buffer (TLB) flush for that virtual address. It already does this to conform with the existing contract the host memory manager 118 has with hardware CPUs on the host 102. The virtualization stack 114 will now intercept such TLB flushes and invalidate the corresponding SLAT entries of any virtual addresses that are flushed that are backing any guest physical memory addresses in any virtual machines. The TLB flush call comes with a range of virtual addresses being flushed. The virtualization stack 114 looks up the virtual addresses being flushed against its data structures 126 indexed by virtual address to find guest physical ranges that may be backed by the given virtual address. If any such ranges are found, the SLAT entries corresponding to those guest physical memory addresses are invalidated. Additionally, the host memory manager can treat virtual allocations that back VMs differently if necessary or desired to optimize TLB flush behavior (e.g., to reduce SLAT invalidation time, subsequent memory intercepts, etc.)

The virtualization stack 114 has to carefully synchronize updating the SLAT 124-1 with the host physical memory page number returned from the virtual fault (serviced by the memory manager 118) against TLB flushes performed by the host 102 (issued by the memory manager 118). This is done to avoid adding complex synchronization between the host memory manager 118 and the virtualization stack 114. The physical page number returned by the virtual fault may be stale by the time it is returned to the virtualization stack 114. For example, the virtual addresses may have already been invalidated. By intercepting the TLB flush calls from the host memory manager 118, the virtualization stack 114 can know when this race occurred and retry the virtual fault to acquire the updated physical page number.

When the virtualization stack 114 invalidates a SLAT entry, any subsequent access to that guest physical memory address by the virtual machine 110-1 will again generate an intercept to the hypervisor 104, which will in-turn be forwarded to the virtualization stack 114 to be resolved as described above. The same process can repeat when a guest physical memory address is accessed for read first and then is written to later. The write will generate a separate intercept because the SLAT entry was only made valid with “Read” access type, That intercept be forwarded to the virtualization stack 114 as usual and a virtual fault with “Write” access will be issued to the host memory manager 118 for the appropriate virtual address. The host memory manager 118 will update its internal state (typically in page table entry (PTE)) to indicate that the host physical memory page is now dirty. This is done before allowing the virtual machine to write to its guest physical memory address to avoid data loss and/or corruption. If and/or when the host memory manager 118 decides to trim that virtual address (which will perform a TLB flush and invalidate the corresponding SLAT entry as a result), the host memory manager 118 will know that the page is dirty and needs to be written to virtual memory on disk, such as a pagefile before being repurposed. This is like what would happen for a regular private virtual allocation in any process running on the host 102.

The host memory manager 118 is able to maintain accurate access history for each virtual page backing the guest physical memory address space just like it does for regular virtual pages allocated in any process address space. For example, an “accessed bit” in the PTE is updated during virtual faults performed as part of handling memory intercepts. When the host memory manager clears the accessed bit on any PTE, it already flushes the TLB on regular CPUs to avoid memory corruption. As described before, this TLB flush will invalidate the corresponding SLAT entry, which in turn will generate an access intercept if the virtual machine 110-1 accesses its guest physical memory address again. As part of handling the intercept, the virtual fault processing in the host memory manager 118 will set the accessed bit again thus maintaining proper access history for the page. Alternatively, for performance reasons to avoid access intercepts in the hypervisor 104 as much as possible, the host memory manager 118 can consume page access information directly from the hypervisor 104 as gathered from the SLAT entries (if supported by the underlying hardware). The host memory manager 118 would cooperate with the virtualization stack 114 to translate access information in the SLAT 124-1 (which is organized by attest physical memory addresses) to the host virtual memory addresses backing those guest physical memory addresses to know which addresses were accessed.

With this foundation, and with reference to FIG. 2, details will now be illustrated for embodiments described herein that can allow files from the host portion 106 to be mapped directly into a guest virtual machine's physical memory 122 address space at creation time such that physical memory spikes on the host can be avoided and/or such that page combining operations can be avoided and/or CPU/IO overhead of reading the pages by the guest from the host can be avoided. Embodiments can improve performance of a given guest virtual machine 110 when accessing these files.

In particular, embodiments can map files, such as the file 136, that are expected to be shared between guest virtual machines directly into the physical address spaces of the guests using VA-backed VM technology, such as that described above, and have the guest virtual machine 110 access them directly using a direct mapping. This involves creating a regular file mapping, as illustrated at 138 in the host portion 106 for the desired file and creating a memory range in the VA-backed VM infrastructure that maps the virtual address range of the file mapping to some guest physical memory 122 address range addressable by the guest virtual machine 110. This way, when the guest virtual machine 110 wants to access that file 136, the memory manager 128 in the guest virtual machine 110 (see FIG. 1) can be told that this file 136 has direct physical address backing instead of the usual disk-based backing. Whenever any guest code of a guest virtual machine 110 accesses memory pages of that file, it will be accessing the guest physical addresses in guest physical memory 122 that are backed by the file mapping on the host portion 106. This avoids the cost of copying data from the host portion 106 to the guest virtual machine 110 and allows multiple guest virtual machines to immediately share the same file pages (see 138) in the physical memory 120 on the host portion 106 (all guest virtual machines will create their own file mappings on the host portion 106 mapping the same file).

Details are now illustrated using an example for sharing a fictional example executable file 136 foo.dll. While an executable file is illustrated, it should be appreciated that embodiments can be used with executable files or data files. Further it should be appreciated that the example illustrated is merely one example, and those of skill in the art will appreciate that the functionality can be accomplished in other ways.

When guest virtual machine 110-1 opens the file foo.dll and creates an image section for the first time, the virtual file client 130 running in the guest virtual machine 110-1 will direct the virtual file server 132 running on the host portion 106 to map the file in the virtual address space 116-1 of the host process 112-1 hosting the guest physical memory 122-1 address space of the guest virtual machine 110-1. The virtual file server 132 will cooperate with a host virtualization driver for this.

Foo.dll is mapped as a regular image mapping in the address space of the process 112-1. For this example, foo.dll is mapped at virtual addresses A through B.

After the mapping, the host virtualization driver adds a memory range to the VA-backed guest virtual machine 110-1 with virtual addresses A through B hosting guest physical addresses X through Y.

The virtual file client 130 running in the guest virtual machine 110-1 receives guest physical addresses X through Y as part of its call to the virtual file server 132.

The virtual file client 130 then responds 10 the memory manager 128 in the guest during the image section callback as supporting a direct mapping for this file.

The guest memory manager 128 and VA-backed VM technology does the rest of the work such that all subsequent guest virtual machine mappings of the image will be accessing guest physical addresses X through Y, which in turn will be backed by host virtual addresses A through B in host the process 112-1, which in turn are backed by image pages in host physical memory 120 from the mapping in the process 112-1.

When guest virtual machine 110-2 accesses foo.dll, the same sequence will repeat and guest virtual machine 110-2 will access the same underlying file 136 in host physical memory 120 on the host portion 106 with no copy overhead, no page combing costs, and no delays in density gains.

This can apply to any read-only file including data files that are expected to be shared between attest virtual machines. Note that in some embodiments, read-write files can also be implemented as will be illustrated in more detail below.

Below are more detailed steps for a particular example of setting up a direct mapped image between a guest virtual machine 110 and the host portion 106. It should be noted that this is one specific example, and other embodiments may use other mechanisms.

For the following example flow, the following legend applies:

G: —code executing in the guest virtual machine 110; H: —code executing on the host portion 106

G: Guest issues open file request for %WINDIR%\foo.dll

G: That open hits a reparse point on the VHD backing the guest virtual machine 110.

G: A filter 134 intercepts the reparse and issues a separate open to virtual file client 130 running in the guest virtual machine 110.

G: virtual file client 130 in-turn opens the corresponding foo.dll on the host portion 106 (wherever it is).

G: Once that create succeeds, the filter 134 copies the file mapping (e.g., the SectionObjectPointers (SOP) in Windows, available from Microsoft Corporation of Redmond, Wash.) from the internally opened (via virtual file client 130) file object to the file object of the original open request.

G: Guest creates an image section on its %WINDIR%\foo.dll opened file.

G: As part of that section creation, the guest virtual machine 110 memory manager 128 issues a file system mapping call to the file system stack.

G: the filter 134 intercepts this and sends it over to the virtual file client 130 via its internally opened file object.

G: the virtual file client 130 sends a command over to the virtual file server 132 on the host portion to determine whether this image can be mapped directly. The virtual file client 130 may supply the guest physical address range to use for this file based on its carved out IO space heap (see more discussion on this in the details section for the host virtualization driver below).

H: virtual file server 132 receives the request and is already running in the context of the worker process hosting the guest virtual machine 110.

H: virtual file server 132 creates an image section for previously locally opened foo.dll and maps an image view of it. For example, it may be mapped in VA: A through B

H: virtual file server 132 communicates the VA information to the host virtualization driver and asks it to create a memory range in the guest virtual machine 110 backed by A through B.

H: host virtualization driver finds an available physical range in the guest virtual machine 110 physical address space. For example, this may be guest physical address: X through Y.

H: host virtualization driver internally creates a memory range for the VA-backed guest virtual machine 110 that has guest physical address X though Y backed by VA A through B. host virtualization driver calls the memory manager 118 to create this range as well.

H: host virtualization driver returns X through Y values to virtual file server 132, which in-turn returns that information to the virtual file client 130 in the guest virtual machine 110.

G: virtual file client 130 receives guest physical address X through Y and records that information in its data structures. An indicator may be returned indication that support for direct map.

G: the memory manager sees support for a direct map flag returned by the file system stack and will eventually issue calls back down to the file system stack during image section construction to request the guest physical addresses.

G: When virtual file client 130 sees a call to request guest physical addresses (forwarded from the filter 134 if necessary), it responds with the appropriate guest physical addresses in the range of X through Y that it recorded above.

G: Guest maps the image view of newly opened image section for %WINDIR%\foo.dll.

G: Guest executes from the image view, which goes through the regular VA-backed guest virtual machine 110 plumbing (SLAT->hypervisor->host virtualization driver->memory manager 118), and actually accesses VA A through B on the host.

### Steps to Tear Down a Direct Mapping

When the guest virtual machine 110 tears down its image section to a direct mapped file, it should be torn down on the host as well, Below are the steps for tearing down a direct mapping.

G: Guest unmaps last image view to %WINDIR%\foo.dll and closes the last handle to its image section. The file handle to %WINDIR%\foo.dll may have been closed at some earlier time (perhaps much earlier) after creating the image section %WINDIR% \foo.dll

G: The memory manager's reference counts on the control area go to 0 so it tears down the control area, which dereferences the file object. When a control area in direct mapped mode, its pages are not on the standby list so whenever its views+section references go to zero, its page frame number count will go to zero in practice as well and hence control will be torn down.

G: virtual file client 130 receives a close request for the file object (potentially via the filter 134 closing its internal file) and sees that the close count went to 0 or whenever it ends up going to 0 if any other entity has the file opened still).

G: virtual file client 130 knows that it set up a direct mapping on this file so it knows that it now needs to tear it down with the host. It issues a command to virtual file server 132 on the host for its corresponding file. Special handling may be needed here if direct mapped pages are still in use by drivers' probe and lock. This is illustrated below in the virtual file client 130 details section.

H: virtual file server 132 communicates to the host virtualization driver to remove the memory range that was created for this direct mapping (in illustrated example, VA: A through B and guest physical address X through Y).

H: host virtualization driver runs down existing virtual faults to the range (none should exist) and holds new intercepts (as per the host virtualization driver and memory manager contract). The host virtualization driver removes the memory ranges from the memory manager 118 and itself. The host virtualization driver resumes virtual faults.

H: virtual file server 132 running in the worker process unmaps the image view of its local foo.dll and closes the image section (it could have closed it right away after opening it).

H: virtual file server 132 returns to the virtual file client 130 in the guest virtual machine 110.

G: virtual file client 130 finishes rest of file tear down as usual.

### Host Virtualization Driver

The host virtualization driver determines which guest physical address space to use for each direct mapping. This cannot overlap with any of the IO space ranges that the guest virtual machine 110 is already using for its devices, etc. There are various ways for this to be performed. The following are some examples.

In one example, the host virtualization driver can pre-allocate a large physical range at guest virtual machine 110 boot time and record it in a system resource affinity table (SRAT) but not as real RAM. Then it would use it as a heap as needed later for direct map purposes.

In an alternative or additional example, a guest virtual file client 130 can request IO space from inside the guest virtual machine 110 and communicate that range via a virtual machine bus to the host virtualization driver. This can be done in large ranges or even per image such that this is fully dynamic.

In an alternative or additional example, the guest virtual file client 130 can reserve IO space in the guest virtual machine 110 and manage the ranges itself and communicate the guest physical addresses to the virtual file server 132 instead of the other way around.

Some embodiments may map images tightly back to back and allocate corresponding guest physical address space back to back so as to have fewer memory ranges in the guest virtual machine 110. This allows for searching of a smaller data structure for the host virtualization driver and memory manager 118 when performing various memory operations.

Some embodiments may align the image mapping in the host and guest physical address assignment on a large page boundary to allow for large TB entries in the future. The memory manager 118 would need to fill the image backing with contiguous page frame numbers.

When some embodiments are used for direct mapping executable images, the host performs the image file virtual layout when the executable is mapped n the host process. This is because image files a e laid out differently in memory than they are on disk. The host memory manager does this and the guest will receive that correctly laid out view via its direct mapping.

Further, the guest may choose to keep the executable image at the same base address (especially for position independent code) or it can chose to rebase the necessary portion of the direct mapping by creating private copies of the modified pages (this way every VM can choose a different base address for security reasons but still share as much as possible with the host).

Typically, embodiments are practiced where direct mapping is performed for read-only files (i.e. files that the guest virtual machine 110 cannot modify but can read/execute from). However, embodiments may implement writeable files as well. Several different alternative embodiments may be implemented. For example, in some embodiments, a guest virtual machine 110 could update the contents of the host file via its direct mapping. In another example, the guest virtual machine 110 maintains private copies of the modified portions of the file while continuing to share the unmodified portions.

Note that the guest virtual machine 110 can still perform various code integrity checks (e.g., hash validation) on the direct mapped executable files because the host 102 provides information to the guest virtual machine 110 that is necessary to validate the executable image even if it has been rebased on the host, in some embodiments, as an optimization, the host 102 can perform all of the code integrity checking on direct mapped executable images and communicate to the guest virtual machine 110 the fact that it was done such that the guest virtual machine 110 can choose to skip its validation in scenarios where the host 102 is trusted.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

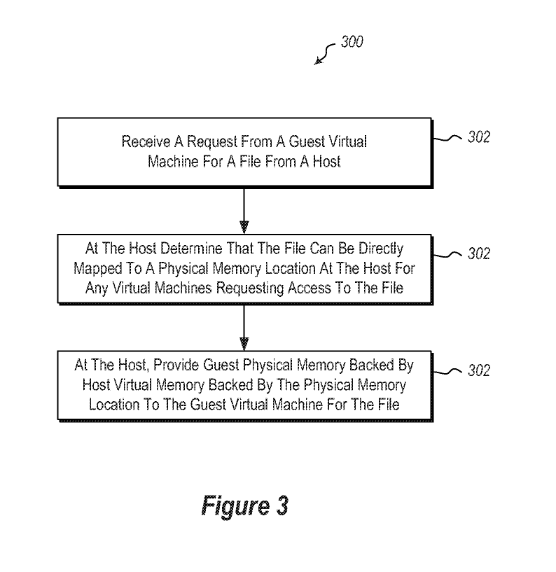

Referring now to FIG. 3, a method 300 is illustrated. The method 300 includes acts for mapping files in host virtual address backed virtual machines. The method 300 includes receiving a request from a guest virtual machine for a file from a host (act 302). For example, the guest virtual machine 110-1 may request a file 36 from the host portion 106.

The method 300 further includes, at the host determining that the file can be directly mapped to a physical memory location for any virtual machines requesting access to the file (act 304). For example, the host portion 106 can determine that the tile 136 can be directly mapped as illustrated at 138.

The method 300 further includes, at the host, providing guest physical memory backed by the file flapping in host virtual memory (act 306). For example, the guest physical memory 122-1 is backed by the host virtual memory 116-1, which is in turn backed by the host physical memory 120.

The method 300 may be practiced where determing that the file can be directly mapped to a physical memory location comprises receiving an indication that the file has direct physical address backing. For example, the host portion 106 can provide an indication that the file 136 is in the physical memory 120.

The method 300 may be practiced where determining that the file can be directly mapped to a physical memory location, comprises guest asking the host to directly map something if the guest knows the file meets its criteria (e.g. the file is read-only). The host may still choose not to directly map it because it knows the file is not going to be shared with many VMs for example, or it will be written by the host, etc.

The method 300 may be practiced where determining that the file can be directly mapped to a physical memory location, comprises determining that the file is a component used to instantiate a plurality of virtual guest machines. Thus, for example, embodiments may be implemented where the file 136 is used as part of a set of files used to instantiate a number of temporary virtual machines. Large numbers of virtual machines could be instantiated using shared files as illustrated herein without the need to have a copy of the file for each virtual machine. Rather, the virtual machines could share the file as illustrated.

The method 300 may be practiced where the file is a compressed file on disk. The method may further include expanding the file from disk into physical memory at the physical memory location at the host. Thus, as illustrated in FIG. 2, the file 136 may be compressed on the disk 140. However, the file may be expanded into the physical memory 120 as illustrated at 138. By expanding the file 136 into the physical memory 120 as shown, direct mapping can be accomplished from the guest physical memory 112-1, to the host virtual memory 116-1, to the host physical memory 120.

The method 300 may further include receiving user input writing to the file, and as a result creating one or more private pages for the file for the virtual machine such that the virtual machine can update a private copy of the file while other virtual machines can continue to obtain access to the file, without updates, by directly mapping to a physical memory location. Thus, for example, if a virtual machine determines that it needs to make changes to a file, it can do so, but it may no longer be able to use the directly mapped copy, but would instead have a private copy.

The method 300 may further include receiving user input writing to the file, and as a result identifying one or more offsets in the file where the user input is applied to the file and creating one or more private pages for portions of the file updated by the user input for the virtual machine such that the virtual machine can update a private copy portion of the file while other virtual machines can continue to obtain access to the file, without updates, by directly mapping to a physical memory location. Thus for example, instead of having a full separate copy of the file for a virtual machine that wishes to write to the file, only modified portions of the file are stored privately for the virtual machine, while unchanged portions are still able o be accessed through the direct backing described above.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
one or more processors; and
one or more computer-readable media having stored thereon instructions that are executable by the one or more processors to configure the computer system to compare recurring processes, including instructions that are executable to configure the computer system to perform at least the following:
receiving a request from a guest virtual machine for a file from a host;
at the host determining that the file can be directly mapped to a physical memory location for any virtual machines requesting access to the file; and
at the host, providing guest physical memory backed by host virtual memory file mapping backed by the host physical memory location to the guest virtual machine for the file.

2. The system of claim 1, wherein determining that the file can be directly mapped to a physical memory location comprises receiving an indication that the guest wishes for the file to be directly mapped.

3. The system of claim 1, wherein determining that the file can be directly mapped to a physical memory location comprises determining that the file is a component used to instantiate a plurality of virtual guest machines.

4. The system of claim 1, wherein the file is a compressed file on disk, and wherein the one or more computer-readable media further have stored thereon instructions that are executable by the one or more processors to configure the computer system to expand the file from disk into physical memory at the physical memory location at the host.

5. The system of claim 1, wherein the one or more computer-readable media further have stored thereon instructions that are executable by the one or more processors to configure the computer system to receive user input writing to the file, and as a result create one or more private portions that are written and that are volatile and not persisted.

6. The system of claim 1, wherein the one or more computer-readable media further have stored thereon instructions that are executable by the one or more processors to configure the computer system to receive user input writing to the file, and as a result persist user changes in a virtual machine local copy which can be later applied locally.

7. The system of claim 1, wherein multiple virtual machines directly map the same host file and simultaneously share the same physical pages on the host.

8. The system of claim 1, wherein the file is an image file and wherein the one or more computer-readable media further have stored thereon instructions that are executable by the one or more processors to configure the computer system to, for an image file mapping, lay out the image virtually and allows the host automatically see the updated layout.

9. A method comprising:
receiving a request from a guest virtual machine for a file from a host;
at the host determining that the file can be directly mapped to a physical memory location for any virtual machines requesting access to the file; and
at the host, providing guest physical memory backed by host virtual memory file mapping backed by the host physical memory location to the guest virtual machine for the file.

10. The method of claim 9, wherein determining that the file can be directly mapped to a physical memory location comprises receiving an indication that the guest wishes for the file to be directly mapped.

11. The method of claim 9, wherein determining that the file can be directly mapped to a physical memory location comprises determining that the file is a component used to instantiate a plurality of virtual guest machines.

12. The method of claim 9, wherein the file is a compressed file on disk, the method further comprising expanding the file from disk into physical memory at the physical memory location at the host.

13. The method of claim 9, further comprising receiving user input writing to the file, and as a result creating one or more private portions that are written and that are volatile and not persisted.

14. The method of claim 9, further comprising receiving user input writing to the file, and as a result persisting user changes in a virtual machine local copy which can be later applied locally.

15. The method of claim 9, wherein multiple virtual machines directly map the same host file and simultaneously share the same physical pages on the host.

16. The method of claim 9, wherein the file is an image file.

17. The method of claim 16, further comprising, for an image file mapping, a host memory manager lays out the image virtually and allows the host to automatically see the updated layout.

18. The method of claim 9, wherein the file is a data file.

19. A host system comprising:
host physical memory;
a host physical memory manager coupled to the host physical memory, wherein the host physical memory manager is configured to perform at least the following:
receiving a request from a guest virtual machine for a file from the host system;
determining that the file can be directly mapped to a physical memory location system for any virtual machines requesting access to the file; and
providing guest physical memory backed by host virtual memory file mapping backed by the host physical memory location to the guest virtual machine for the file.

20. The system of claim 1, wherein determining that the file can be directly mapped to a physical memory location comprises determining that the file is a component used to instantiate a plurality of virtual guest machines.
